(19) United States
(12) Patent Application Publication
(10) Pub. No.: US 2015/0212923 A1
(43) Pub. Date: Jul. 30, 2015

(54) NONTRANSITORY PROCESSOR READABLE RECORDING MEDIUM HAVING FAULT INJECTION PROGRAM RECORDED THEREIN AND FAULT INJECTION METHOD

(71) Applicant: Kabushiki Kaisha Toshiba, Tokyo (JP)

(72) Inventors: Tetsuya Sugiyama, Yokohama Kanagawa (JP); Tsutomu Unesaki, Hachioji Tokyo (JP); Masayuki Shibaoka, Yokohama Kanagawa (JP); Takashi Omizo, Kawasaki Kanagawa (JP)

(21) Appl. No.: 14/482,058

(22) Filed: Sep. 10, 2014

(30) Foreign Application Priority Data
Jan. 28, 2014 (JP) 2014-013806

(51) Int. Cl. G06F 11/36

(52) U.S. Cl. CPC G06F 11/362; G06F 11/3644

(57) ABSTRACT

According to one embodiment, a program causes a processor to perform providing, by a fault injection module, cooperation information to a debug function. The program causes a processor to perform receiving, by the fault injection module, a notification of at least one of condition related information and action related information as a response to the cooperation information from the debug function. The program causes a processor to perform determining, by the fault injection module, at least one of a fault injection condition and a fault injection action based on the notification. The program causes a processor to perform creating, by the fault injection module, a fault injection scenario that defines a fault injection procedure with respect to the fault injection target based on at least one of the determined fault injection condition and fault injection action.

### CROSS-REFERENCE TO RELATED APPLICATIONS

This application is based upon and claims the benefit of priority from Japanese Patent Application No. 2014-013806, filed on Jan. 28, 2014; the entire contents of which are incorporated herein by reference.

### FIELD

Embodiments described herein relate generally to a nontransitory processor readable recording medium having a fault injection program recorded therein and a fault injection method.

### BACKGROUND

When performing a fault injection to a fault injection target regarding a control program that runs using a fault injection target, if a data pattern causing a fault is determined through trial and error and is injected to the fault injection target, users are often forced to perform cumbersome procedures. Therefore, it is desired to reduce the burden on users in fault injection.

### BRIEF DESCRIPTION OF THE DRAWINGS

FIG. 1 illustrates a configuration of a fault injection system including a fault injection program according to a first embodiment;

FIG. 2 is a sequence diagram illustrating an operation of the fault injection system including the fault injection program according to the first embodiment;

FIG. 3 illustrates an operation of the fault injection system including the fault injection program according to the first embodiment;

FIGS. 4A and 4B illustrate an operation of a fault injection system including a fault injection program according to a modification of the first embodiment;

FIG. 5 illustrates an operation of the fault injection system including the fault injection program according to the modification of the first embodiment;

FIG. 6 illustrates an operation of a fault injection system including a fault injection program according to another modification of the first embodiment;

FIG. 7 illustrates an operation of the fault injection system including the fault injection program according to another modification of the first embodiment;

FIG. 8 is a sequence diagram illustrating an operation of a fault injection system including a fault injection program according to a second embodiment;

FIG. 9 illustrates an operation of the fault injection system including the fault injection program according to the second embodiment;

FIGS. 10A and 10B illustrate an operation of a fault injection system including a fault injection program according to a modification of the second embodiment;

FIG. 11 illustrates an operation of a fault injection system including a fault injection program according to another modification of the second embodiment;

FIG. 12 is a sequence diagram illustrating an operation of a fault injection system including a fault injection program according to a third embodiment;

FIG. 13 illustrates an operation of the fault injection system including the fault injection program according to the third embodiment; and

FIGS. 14A and 14B illustrate an operation of a fault injection system including a fault injection program according to a modification of the third embodiment.

### DETAILED DESCRIPTION

In general, according to one embodiment, there is provided a nontransitory processor readable recording medium having a fault injection program recorded therein. The program causes a processor to perform providing, by a fault injection module, cooperation information to a debug function that performs debugging of a control program, which is operated by using a fault injection target. The program causes a processor to perform receiving, by the fault injection module, a notification of at least one of condition related information and action related information as a response to the cooperation information from the debug function. The program causes a processor to perform determining, by the fault injection module, at least one of a fault injection condition and a fault injection action based on the notification. The program causes a processor to perform creating, by the fault injection module, a fault injection scenario that defines a fault injection procedure with respect to the fault injection target based on at least one of the determined fault injection condition and fault injection action.

Exemplary embodiments of a fault injection program will be explained below in detail with reference to the accompanying drawings. The present invention is not limited to the following embodiments.

### First Embodiment

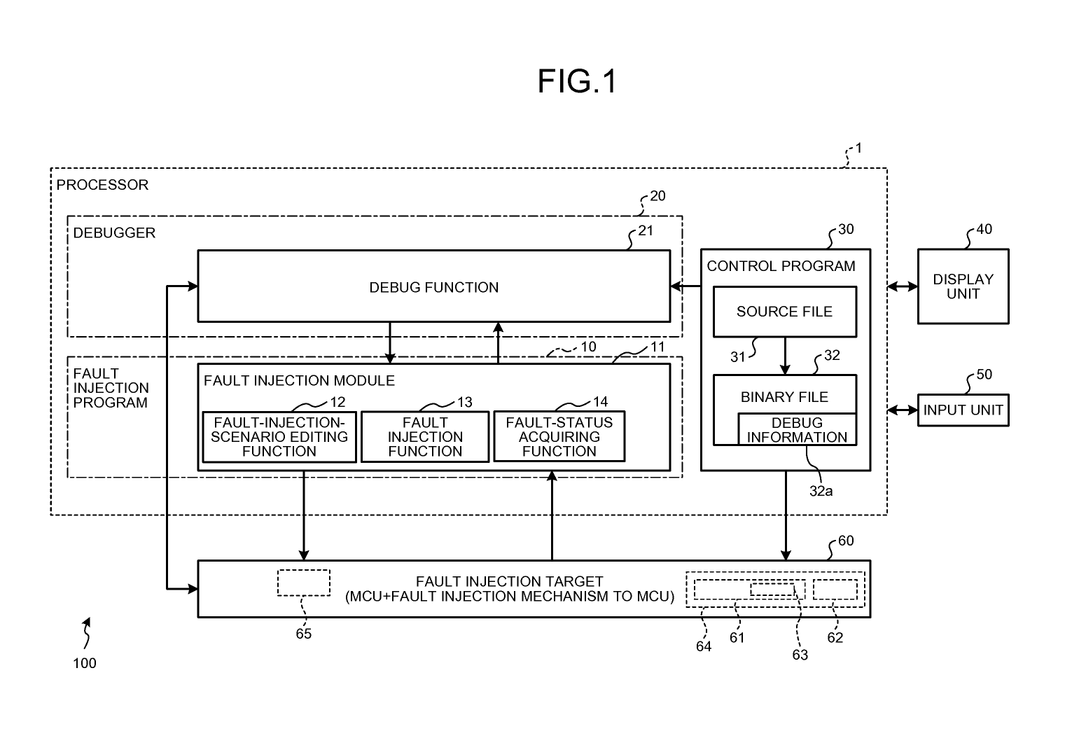

FIG. 1 illustrates a configuration of a fault injection system 100 according to a first embodiment. The fault injection system 100 includes a fault injection program 10 and a debugger 20.

A control program 30 uses the fault injection program 10 to inject a fault to a fault injection target 60. The fault injection target 60 can be an FPGA (Field Programmable Gate Array) or a simulator. The simulator can be hardware that performs similar action to an MCU (microcomputer), or can be software that performs similar action to the MCU (microcomputer). The fault injection target 60 includes an MCU 64 and a fault injection mechanism 65 (a fault injection circuit for injecting a fault to the MCU 64). The MCU 64 includes a CPU (Central Processing Unit) 61 and a memory 62. The CPU 61 includes a register 63. A fault is injected to the MCU 64 by causing a fault by setting a value of the register 63 to an inappropriate value, or causing a fault by setting a value of the memory 62 to an inappropriate value. At this time, similar method to setting a breakpoint performed for debugging is applied to setting of a fault injection point.

The fault injection program 10 is installed in a processor 1 via a recording medium or a network. The processor 1 activates the fault injection program 10 according to a fault-injection activation command received from a user via an input unit 50 to expand a fault injection module 11 (a functional module) into the processor 1. In the first embodiment, the fault injection module 11 cooperates with a debug function 21 to create a fault injection scenario that defines a fault injection procedure with respect to the fault injection target 60. Accordingly, a fault can be injected without stopping the control program 30, and the burden on the user in the fault injection can be reduced. The fault injection module 11 includes a fault-injection-scenario editing function 12, a fault injection function 13, and a fault-status acquiring function 14.

The fault injection module 11 determines a fault injection condition and a fault injection action in cooperation with the debug function 21. The fault injection condition includes a timing condition that specifies a timing to perform fault injection. The timing condition includes a program counter value corresponding to the timing to perform fault injection at the time of executing the control program 30. The fault injection action includes an action entry to specify a fault injection action. The fault injection module 11 creates the fault injection scenario according to the determined fault injection condition.

Specifically, the fault injection module 11 acquires timing information from the debug function 21 to determine the timing condition. For example, the fault injection module 11 determines the notified program counter value as the timing condition.

The fault injection module 11 provides the cooperation information to the debug function 21 at the time of being expanded in the processor 1 (or according to a request from the debug function 21). Accordingly, the debug function 21 starts a cooperation action to cooperate with the fault injection module 11. The cooperation information includes cooperation menu objects. The debug function 21 causes the display unit 40 to display the cooperation menu objects on a screen in response to an instruction from a user. The cooperation menu objects are displayed overlapped on each other on a predetermined window on the display unit 40. Accordingly, the user can be prompted to select a fault injection timing that is related to the predetermined window. When the user selects a desired line of code (a desired source line) as a fault injection point in the cooperation menu object, the debug function 21 refers to the debug information to notify the fault injection module 11 of the program counter value corresponding to the desired line of code as the timing information.

It should be noted that the debug function 21 creates the information used for debugging of the control program 30 as debug information 32a. When a compiler (not shown) compiles a source file 31 to a binary file 32, the created debug information 32a is added to the binary file 32 in the control program 30 by the compiler. The debug information 32a includes information in which the program counter value is associated with each line of code of the program. The program counter value is a memory address indicating an arrangement position of the line of code in the memory 62. The program counter value is stored in a program counter (a PR register) at the time of executing the line of code.

The debug function 21 causes the display unit 40 to display a setting window corresponding to the cooperation information on the screen. Accordingly, a user can be prompted to select a fault injection action. When the user selects a fault injection action in association with the desired line of code, the debug function 21 notifies the fault injection module 11 of information of the fault injection action. That is, the debug function 21 notifies the fault injection module 11 of the action information in association with the timing information as a response to the cooperation information. The fault injection module 11 determines an action entry based on the action information.

The fault-injection-scenario editing function 12 creates the fault injection scenario based on the timing condition and the action entry. The fault-injection-scenario editing function 12 creates a condition description based on the timing condition and writes the condition description in the fault injection scenario. The condition description includes a description indicating that the line defines the condition and the description that define condition contents. The fault-injection-scenario editing function 12 also creates an action description based on the action entry and writes the action description in the fault injection scenario. The action description includes a description indicating that the line defines an action, and a description that defines action contents.

The fault injection function 13 converts the fault injection scenario to data for the fault injection mechanism 65. The fault injection function 13 converts the fault injection scenario to binary data in a machine language. The fault injection function 13 writes the data of the converted fault injection scenario in the fault injection mechanism (e.g., a fault injection circuit) 65. The fault injection mechanism 65 has a function of interpreting and executing the fault injection scenario independently of execution of the control program 30 in the MCU 64. Therefore, in a state where the control program 30 being continuously executed in the MCU 64, the fault injection mechanism 65 executes fault injection to the MCU 64 according to the fault injection scenario. The fault injection mechanism 65 performs an action defined in the action description (i.e., a fault injection action to the MCU 64) in response that the condition defined in the condition description is established.

After execution of fault injection is complete, the fault-status acquiring function 14 acquires an execution result of the fault injection scenario from the fault injection target 60. For example, because the fault injection mechanism 65 notifies the fault-status acquiring function 14 that the execution of fault injection is complete, the fault-status acquiring function 14 acquires the execution result. Alternatively, the fault-status acquiring function 14 monitors a status of the MCU 64 in a predetermined cycle to recognize that the execution of fault injection is complete, and acquires the execution result. The fault-status acquiring function 14 notifies the debug function 21 of the execution result. The debug function 21 displays the execution result on a trace window.

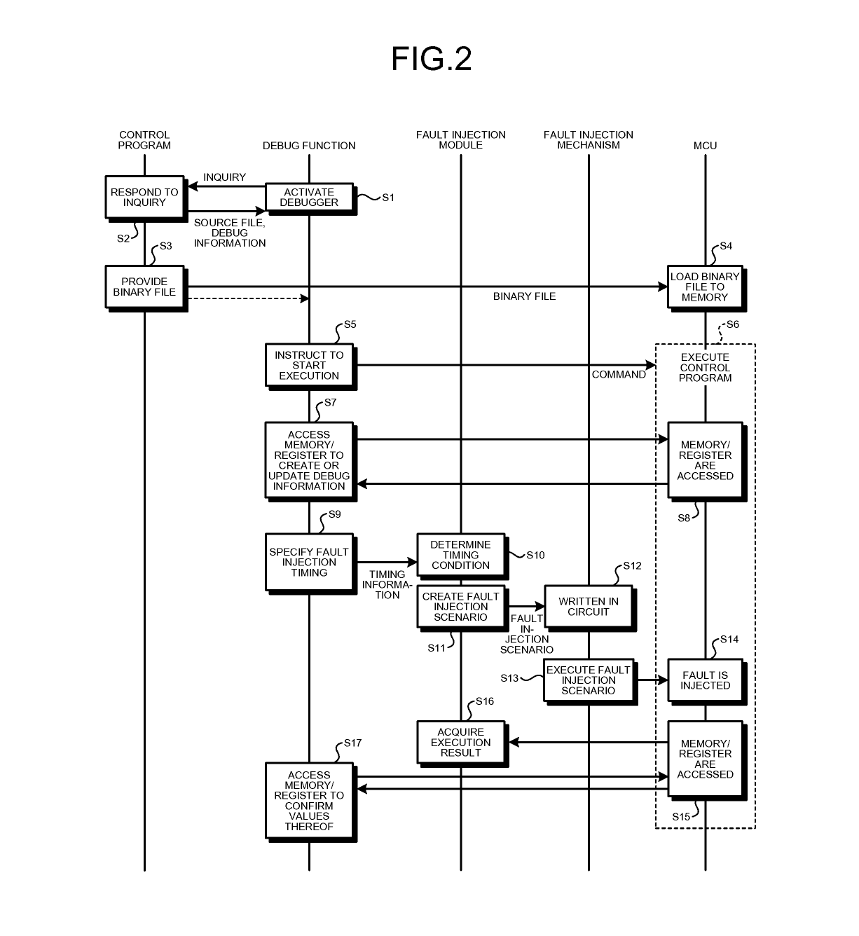

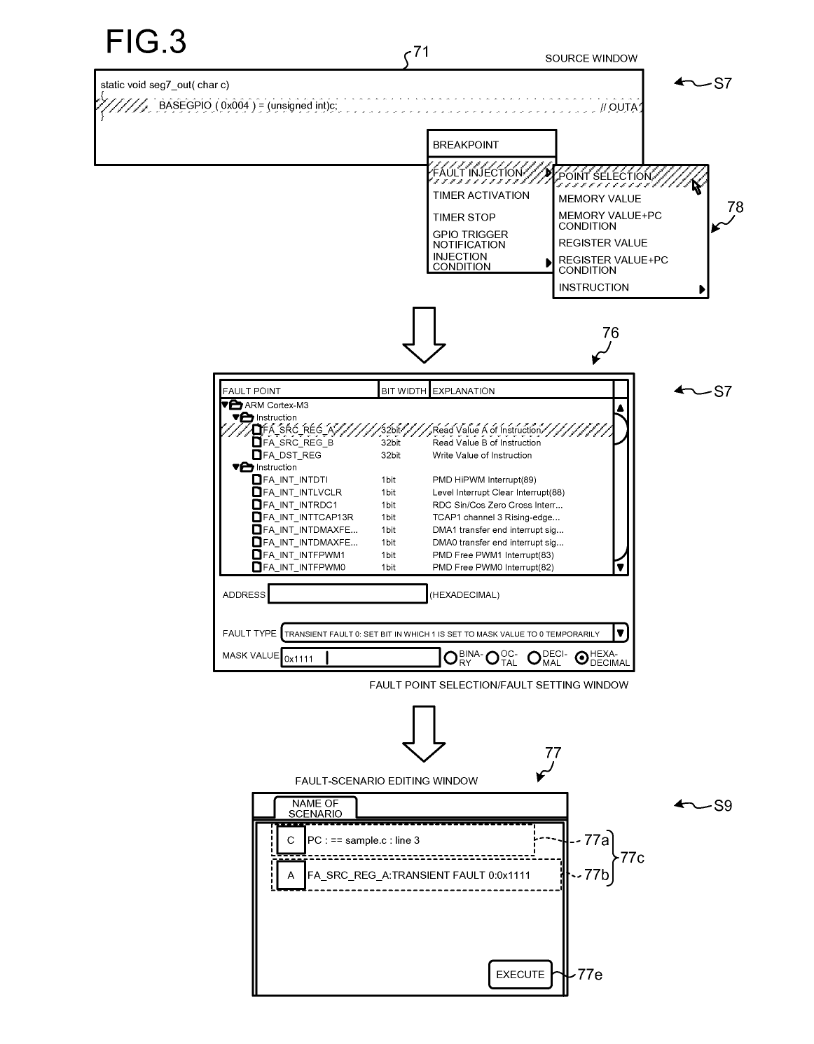

Actions of the fault injection program 10 are explained next. FIG. 2 is a sequence diagram illustrating an action of the fault injection system 100. FIG. 3 illustrates an example of windows to be displayed by the action of the fault injection system 100. In FIG. 3, a case where the source code in a C language is displayed on a source window 71 is exemplified.

The debug function 21 activates the debugger 20 according to a debugger activation command received from a user via the input unit 50 (S1), and causes the display unit 40 to display the source window 71 (see FIG. 3) on the screen. The debug function 21 makes an inquiry to the control program 30 about contents to be debugged. The control program 30 responses to the inquiry (S2), and supplies the source file 31 to the debug function 21. When there is the debug information 32a, the control program 30 supplies the debug information 32a to the debug function 21. The debug function 21 reads the source file 31 and the debug information 32a. The control program 30 supplies the binary file 32 to the MCU 64 (S3). The binary file 32 is loaded onto the MCU 64 (S4).

The debug function 21 supplies a control-program activation command received from the user via the input unit 50 to the MCU 64 (S5). The MCU 64 starts execution of the control program 30 according to the control-program activation command. The MCU 64 continues execution of the control program 30 until a control-program stop command or a control-program end command is received (S6). Upon reception of the control-program stop command, the MCU 64 temporarily stops execution of the control program 30. However, upon reception of a control-program restart command thereafter, the MCU 64 restarts execution of the control program 30.

The debug function 21 temporarily causes the MCU 64 to stop execution of the control program 30 in response to the control-program stop command received from the user via the input unit 50. The debug function 21 accesses the memory 62 and the register 63 and causes the display unit 40 to display values of the memory 62 and the register 63 on the screen. The user performs debugging by using an editor (not shown) based on the displayed values of the memory 62 and the register 63. The debug function 21 causes the MCU 64 to restart execution of the control program 30 in response to the control-program restart command received from the user via the input unit 50. The debug function 21 creates or updates the debug information 32a based on the debugged result (S7 and S8). The debug function 21 acquires trace information or the like. When the contents of the source file 31 are changed by the debugging, the processes from S3 to S6 can be performed again.

The debug function 21 specifies timing information (S9). At this time, the debug function 21 refers to the debug information 32a to specify the timing information. When the fault injection module 11 is expanded in the processor 1 (or in response to a request from the debug function 21), a cooperation menu object 78 is supplied beforehand from the fault injection module 11 to the debug function 21.

When the user selects a desired line of code on the source window 71 on which the source code is displayed to perform a predetermined operation, the debug function 21 causes the display unit 40 to display the cooperation menu object 78. For example, when the user right-clicks a mouse in a state where the user drags the mouse to select a line of code, the cooperation menu object 78 is displayed. FIG. 3 illustrates a state where a line of code “BASEGPIO(0x004)=(unsigned int)c;” is selected and highlighted.

In the cooperation menu object 78, when the user selects “fault injection”→“point selection”, the debug function 21 displays a ‘fault-point selection/fault setting window’ 76 on the screen. When a fault type is selected by the user on the ‘fault-point selection/fault setting window’ 76, the debug function 21 refers to the debug information 32a to specify the program counter value corresponding to the selected line of code.

The debug function 21 converts the program counter value to data for the fault injection module 11, and notifies the fault injection module 11 of the program counter value as the timing information. The debug function 21 converts the selected information of the fault injection action to the data for the fault injection module 11, and notifies the fault injection module 11 of the action information.

The fault injection module 11 edits the scenario by using the fault-injection-scenario editing function 12 based on the information notified from the debug function 21. The fault injection module 11 determines the timing condition based on the timing information (S10). The fault injection module 11 also determines an action entry for fault injection based on the action information.

The fault-injection-scenario editing function 12 creates a fault injection scenario 77c according to the timing condition and the action entry (S11). The fault-injection-scenario editing function 12 creates a condition description 77a according to the timing condition and writes the condition description 77a in the fault injection scenario 77c. The created fault injection scenario 77c is displayed on a fault-scenario editing window 77. In the condition description 77a in FIG. 3, “C” defines the condition, and “PC:==sample.c:line3” defines the contents of the condition. The description indicates that a fault is injected at a timing when a program counter value (PC) stored in a program counter becomes a program counter value allocated to the third line of code in a source file “sample.c”. When the source code is edited on the source window 71 and a line number is changed by editing, the fault-injection-scenario editing function 12 receives a notification of this matter from the debug function 21 and updates the line number in the condition description 77a.

The fault-injection-scenario editing function 12 creates an action description 77b according to the action entry and writes the action description 77b in the fault injection scenario 77c. In the action description 77b in FIG. 3, “A” defines an action, and “FA_SRC_REG_A: TRANSIENT FAULT 0:0x1111” defines the contents of the action. The description indicates that a fault occurs in a value of a register “REG_A”. Upon reception of a command corresponding to an instruction from a user, the fault-injection-scenario editing function 12 can perform editing such as rewrite of the fault injection scenario 77c on the fault-scenario editing window 77.

In the fault injection scenario 77c, a plurality of sets of the condition description 77a and the action description 77b can be described. For example, the condition description 77a corresponds to the action description 77b immediately below thereof. Alternatively, a plurality of condition descriptions 77a can be continuously described in a plurality of lines. When a description indicating an AND condition or an OR condition is added to a line head of the second line and thereafter, and a condition expression indicated by the condition descriptions 77a is established, an action corresponding to the action description 77b immediately below thereof is performed.

The fault injection function 13 converts the fault injection scenario 77c to the data for the fault injection mechanism 65, and writes the converted fault injection scenario 77c in the fault injection mechanism (a fault injection circuit) 65. The fault injection function 13 converts the fault injection scenario 77c and writes the converted fault injection scenario 77c in the fault injection mechanism 65, in response that an execution button 77e on the fault-scenario editing window 77 is pressed.

The fault injection mechanism 65 executes fault injection according to the data of the fault injection scenario 77c (S13). That is, in a state where execution of the control program 30 being continuously performed by the MCU 64, the fault injection mechanism 65 accesses the MCU 64 at the fault injection timing (a timing at which a condition of “PC:==sample.c:line3” shown in FIG. 3 is established) to perform fault injection. Accordingly, a fault is injected into the MCU 64, by setting the value of the register 63 to an inappropriate value or the value of the memory 62 to an inappropriate value (S14).

The fault-status acquiring function 14 acquires the execution result of the fault injection scenario 77c from the fault injection target 60 (S15 and S16). The fault-status acquiring function 14 notifies the debug function 21 of the execution result. The debug function 21 displays the execution result on the screen. The debug function 21 temporarily causes the MCU 64 to stop execution of the control program 30 in response to the control-program stop command received from a user via the input unit 50. The debug function 21 accesses the memory 62 and the register 63 and causes the display unit 40 to display the values of the memory 62 and the register 63 on the screen, according to a confirmation command received from the user via the input unit 50 (S17 and S15). The debug function 21 causes the MCU 64 to restart execution of the control program 30 in response to the control-program restart command received from the user via the input unit 50. Accordingly, because the user can refer to the values of the memory 62 and the register 63 together with the execution result, the user can confirm the detailed fault condition.

As described above, according to the first embodiment, in the fault injection program 10, the fault injection module 11 determines the fault injection condition and the fault injection action in cooperation with the debug function 21. For example, the fault injection module 11 provides the cooperation information to the debug function 21. The debug function 21 specifies the timing information and the action information based on the cooperation information, and notifies the fault injection module 11 of the specified pieces of information. That is, the fault injection module 11 receives a notification of the timing information as condition related information, and a notification of the action information as action related information. The fault injection module 11 determines the fault injection condition and the fault injection action based on the notified condition related information and action related information. The fault injection module 11 creates the fault injection scenario 77c that defines the fault injection procedure with respect to the fault injection target 60 based on the determined fault injection condition and fault injection action. Accordingly, a fault injection timing (a condition) can be easily set in cooperation with the debug function 21, and a fault can be injected without stopping the control program 30, thereby enabling to reduce the burden on the user in fault injection.

Furthermore, according to the first embodiment, because a fault injection timing (a condition) can be easily set in cooperation with the debug function 21, and a fault can be injected without stopping the control program 30, the fault occurrence status can be displayed straightforwardly, even during execution of the control program 30. Accordingly, because the behavior of the program after fault injection (for example, whether an appropriate fault avoidance action has been performed) can be easily confirmed, fault injection and debugging of the control program 30 can be seamlessly performed.

According to the first embodiment, the fault injection module 11 provides the cooperation information to the debug function 21. The debug function 21 causes the display unit 40 to display the cooperation menu object corresponding to the cooperation information on the screen in response to an instruction from a user. Accordingly, the user can be prompted to select the fault injection timing. When the user select a desired line of code as the fault injection point in the cooperation menu object, the debug function 21 refers to the debug information 32a to specify the program counter value corresponding to the desired line of code as the timing information, and notifies the fault injection module 11 of the timing information. The fault injection module 11 determines the fault injection condition based on the notified timing information. Accordingly, the fault injection module 11 can determine the fault injection condition in cooperation with the debug function 21.

According to the first embodiment, in the fault injection program 10, the fault injection module 11 acquires the timing information that is related to the timing to perform fault injection from the debug function 21. The fault injection module 11 determines the timing condition based on the acquired timing information. Accordingly, the fault injection module 11 can easily set a fault injection timing (a condition) in cooperation with the debug function 21.

It should be noted that the fault injection module 11 can make an inquiry to the debug function 21 about easily acquirable information by using the debug function. For example, the fault injection system 100 can perform the following operations before performing the operation at S9.

Once debugging is complete, the debug function 21 provides the debugged source file 31 to the fault injection module 11. The fault injection module 11 analyzes a source code of the provided source file 31 to select an appropriate point (a position on the source code) to perform fault injection. The fault injection module 11 parses the source code to specify a critical line of code with respect to a fault avoidance operation in a specified data structure, and selects the line of code as the fault injection point. The fault injection module 11 can specify a line of code to be executed first, of the plurality of lines of code to realize the fault avoidance action (a line of code in which an initial value is assigned to a variable) as the critical line of code. The fault injection module 11 makes an inquiry to the debug function 21 about the information (the program counter value) corresponding to the selected point.

In this case, at S9, the debug function 21 refers to the debug information 32a in response to the inquiry from the fault injection module 11 to notify the fault injection module 11 of the timing information. The debug function 21 also notifies the fault injection module 11 of the action information. Actions after S10 are performed in similar manner.

In this manner, instead of a user, the fault injection module 11 selects the fault injection point. The fault injection module 11 makes an inquiry to the debug function 21 about the timing information that is related to the point analyzed and selected to acquire the timing information. Accordingly, the fault injection timing can be selected without performing any interactive operation with the user. Accordingly, the burden on the user in fault injection can be reduced further.

Alternatively, although the MCU 64 in FIG. 1 is included in the fault injection target 60, the MCU 64 can be independent of the fault injection target 60. In this case, if the fault injection target 60 and the MCU 64 are connected by a control line, and the fault injection mechanism 65 can access the MCU 64, a fault can be injected to the MCU 64 from the fault injection mechanism 65.

Alternatively, the debug function 21 can be included in the fault injection program 10. In this case, when the fault injection program 10 is activated, a debug function window and the fault-scenario editing window 77 can be displayed on the window of the fault injection program 10. In this manner, because the debug function 21 and the fault injection module 11 are integrated in one program, the fault injection module 11 can cooperate with the debug function 21 more easily.

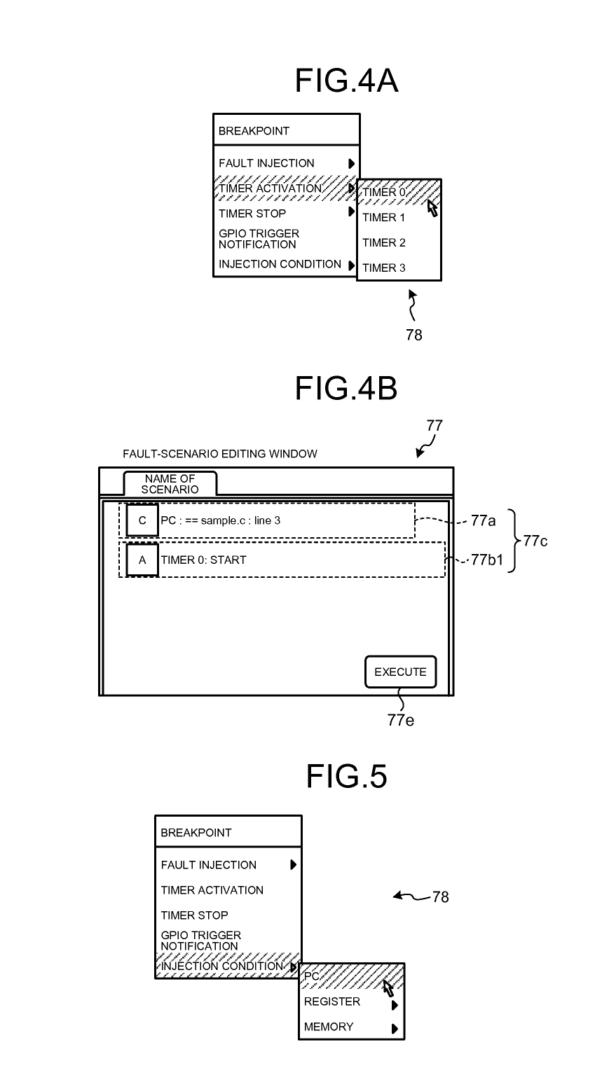

Alternatively, a timing to start a timer count can be determined as the timing to perform fault injection instead of determining the timing itself to perform fault injection. FIGS. 4A and 4B illustrate a selected state of a cooperation menu object used when a timing to start a timer count is determined. In specifying the fault injection timing (S9), when a user selects “timer activation”→“timer 0” in the cooperation menu object 78 (FIG. 4A), the debug function 21 recognizes the desired line of code as the timing to start the timer count. That is, the debug function 21 recognizes, as the timing to perform fault injection, the timing after a predetermined period has been counted at the timer 0 after execution of the desired line of code. The debug function 21, in response that the desired line of code is selected as a count start timing of the timer, refers to the debug information 32a to specify the program counter value corresponding to the desired line of code.

A timer period different from each other can be set to a plurality of candidates “timer 0” to “timer 3” to be selected by “timer activation”. For example, 5 milliseconds can be set to “timer 0”, 10 milliseconds can be set to “timer 1”, 15 milliseconds can be set to “timer 2”, and 20 milliseconds can be set to “timer 3”, and these correspondence relations can be stored beforehand in the processor 1 as timer period information.

The debug function 21 converts the program counter value to the data for the fault injection module 11 and notifies the fault injection module 11 of the data as the timing information (the condition related information). Furthermore, the debug function 21 converts the information of the timer to be counted to the data for the fault injection module 11 and notifies the fault injection module 11 of the data as the timer information (the action related information).

Actions performed at S10 to S12 when the program counter value is used as the timing condition are explained below in detail. The fault injection module 11 determines the program counter value as the timing condition (S10). The fault injection module 11 also determines an action entry to specify a timer action based on the timer information.

As shown in FIG. 4B, the fault-injection-scenario editing function 12 creates the condition description 77a based on the timing condition (a condition related to the program counter value) and an action description 77b1 based on the action entry, and writes these descriptions in the fault injection scenario 77c, respectively (S11 and S12). In the action description 77b1, “A” defines an action and “timer 0: start” defines the contents of the action. This description indicates a timer action that counts a predetermined period (for 5 milliseconds) by starting to count the timer 0.

In the fault injection scenario 77c, if the action description 77b similar to that of the first embodiment is added immediately below the action description 77b1, the scenario can be used when it is desired to cause a fault after n seconds (“n” is an arbitrary positive number) after the timing condition is established. For example, the scenario can be used when a fault is injected after 5 milliseconds since the start of execution of a program counter value PC=0x1000. In this case, the fault injection function 13 can specify a period to be counted by the timer by referring to the timer period information, and performs monitoring for 5 milliseconds under the timer condition after activation of the timer.

In this manner, the timing to start timer count is determined with respect to the fault injection timing and included in the condition description, and the timer action is determined and included in the action description, thereby enabling to create the fault injection scenario 77c. Accordingly, the fault injection module 11 can set the fault injection timing under complicated conditions (timer condition=timing condition+timer action) in cooperation with the debug function 21.

Alternatively, instead of determining the fault injection point on the source window 71 written in the C language, the fault injection point can be determined on a disassembly window 71′. The debug function 21 acquires the binary file 32 after the source file 31 is compiled to the binary file 32 at the time of activation of the debugger 20 (see the broken arrow extending from S3 in FIG. 2). The debug function 21 disassembles the binary file 32 and causes the display unit 40 to display a description in an assembly language between corresponding lines with respect to the respective lines in the source code in the C language on the source window 71. That is, the debug function 21 causes the display unit 40 to display the source code in the C language and the description in the assembly language in a mixed state on the disassembly window 71′.

It should be noted that, in the present specification, the mixed display of the source code in the C language and the description in the assembly language is also referred to as “disassembly window 71′” to be distinguished from the source window 71 in a state where the description in the assembly language is not displayed. Furthermore, in order to distinguish the source window 71 from the disassembly window 71′, the source window 71 is also referred to as “C source window 71”.

In a modification of the first embodiment, when the user selects a desired line of code in the description in the assembly language on the disassembly window 71′ to perform a predetermined operation, the debug function 21 displays the cooperation menu object 78. For example, a line of code in the description in the assembly language “000001da:f2410304 moves r3, #4100” corresponding to a line of code “BASEGPIO(0x004)=(unsingned int)c;” is selected, and highlighted and displayed on the screen. In the description, “r3” denotes a register address, and “#4100” denotes a memory address. Subsequent actions of the modification are similar to those of the first embodiment.

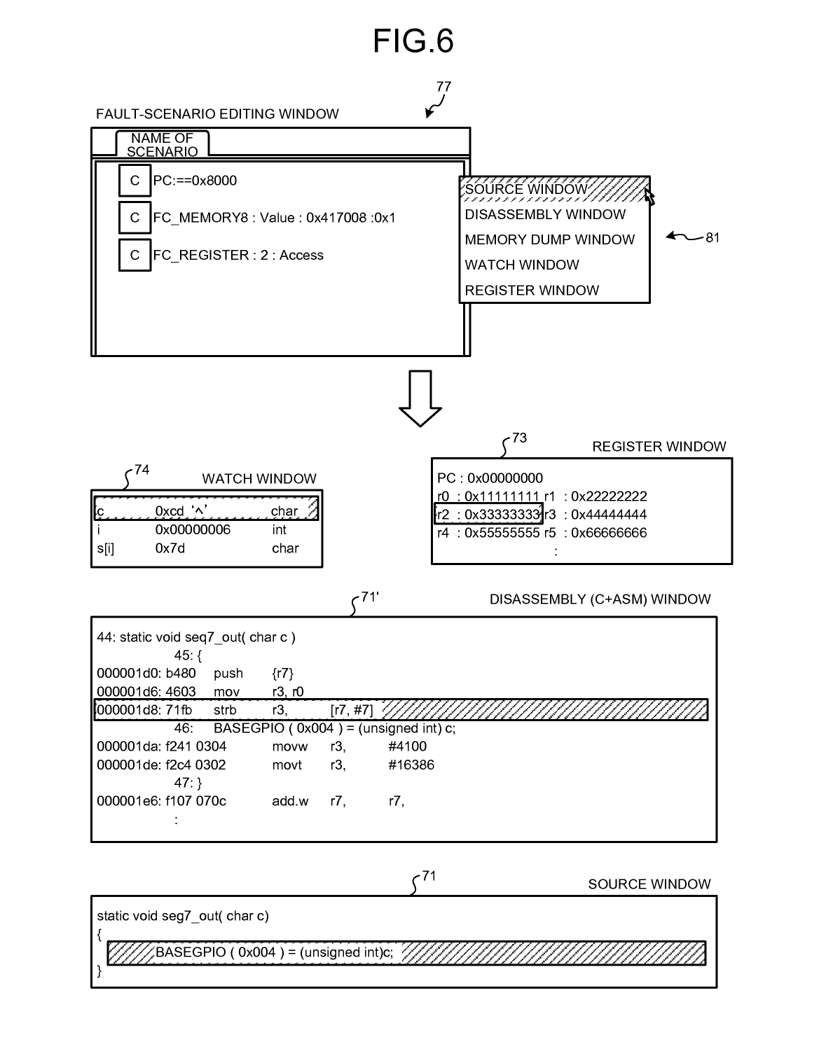

In this manner, the fault injection module 11 can determine the timing condition in cooperation with the disassembly window 71′ (see FIG. 6). Accordingly, because the timing condition can be determined while confirming the register address and the memory address to be used in execution of the line of code, the timing condition can be accurately determined.

Alternatively, in editing of the fault injection scenario 77c, instead of editing the condition description 77a in a form related with the operation description 77b, the condition description 77a can be edited in a form independent of the action description 77b. In this case, the fault-injection-scenario editing function 12 can edit the condition description 77a in the form independent of the action description 77b. Accordingly, the fault injection module 11 can easily improve the flexibility at the time of editing the fault injection scenario 77c.

For example, the timing condition (a condition related to the program counter value) can be created from the source code in the C language. The debug function 21 causes the display unit 40 to display the cooperation menu object 78 overlapped on the source window 71 (or the disassembly window). In the cooperation menu object 78 in a state where the desired line of code is selected, when “injection condition”→“PC” is selected as shown in FIG. 5, the debug function 21 notifies the fault injection module 11 of a program counter value corresponding to the desired line of code as a fault timing. Accordingly, the fault injection module 11 determines the program counter value as the timing condition. The fault-injection-scenario editing function 12 then creates the condition description 77a independently and writes the condition description 77a in the fault injection scenario 77c.

Alternatively, the fault injection system 100 can have a function of jumping from the fault-scenario editing window 77 to the respective windows 71 to 74 of the debug function 21, as an interface function between the fault injection module 11 and the debug function 21. Accordingly, it can be confirmed whether the fault injection timing specified in the fault injection scenario 77c is appropriate.

For example, as shown in FIG. 6, the fault injection module 11 causes the display unit 40 to display a cooperation menu object 81 overlapped on the fault-scenario editing window 77. When the “source window” is selected in the cooperation menu object 81 by a user, in a state where a cursor is positioned on a predetermined condition description, the fault injection module 11 notifies the debug function 21 of the timing information corresponding to the condition description. The debug function 21 refers to the debug information 32a to specify a line of code on the source code corresponding to the timing information (the program counter value). Accordingly, the fault injection module 11 causes the display unit 40 to jump the cursor to the source window 71, and the debug function 21 causes the display unit 40 to highlight and display a line of code that is related to the fault injection scenario 77c on the source window 71.

Alternatively, when a user selects a “disassembly window” in the cooperation menu object 81, in a state where the cursor is positioned on the predetermined condition description, the fault injection module 11 notifies the debug function 21 of the timing information corresponding to the condition description. The debug function 21 refers to the debug information 32a to specify a line of code on the source code corresponding to the timing information (the program counter value). Accordingly, the fault injection module 11 causes the display unit 40 to jump the cursor to the disassembly window 71′ and the debug function 21 causes the display unit 40 to highlight and display a line of code that is related to the fault injection scenario 77c on the disassembly window 71′.

Alternatively, the debug function 21 can cause the display unit 40 to display an execution result of the fault injection scenario 77c on the screen in such a form that a fault injection point and a fault occurrence point can be identified respectively. Accordingly, the fault occurrence status and the like can be displayed straightforwardly and association between the fault injection point and the fault occurrence point can be easily ascertained.

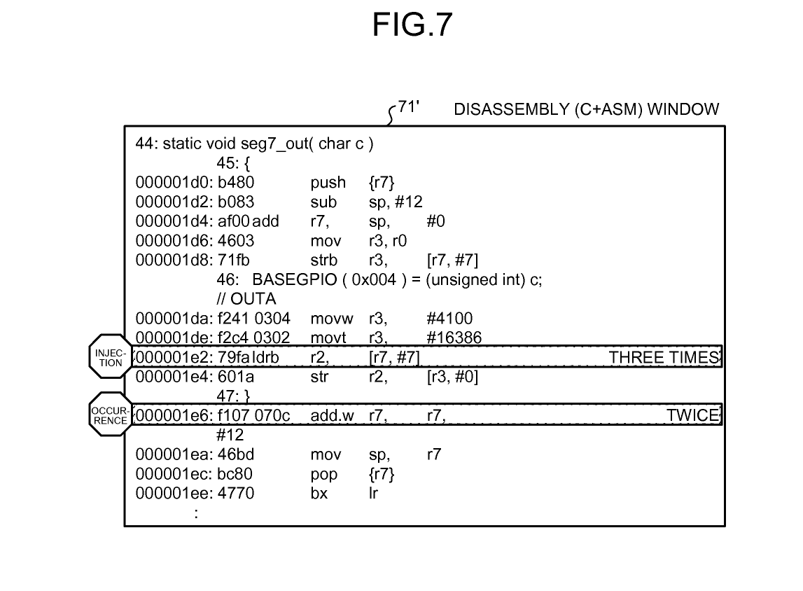

For example, as shown in FIG. 7, a fault status (an execution result of the fault injection scenario 77c) can be displayed on the source code. The debug function 21 can cause the display unit 40 to display an injection timing and an occurrence timing of a fault due to fault injection on the disassembly window 71′. The debug function 21 indicates the fault injection timing by “injection” and indicates the number of injections (three times). Furthermore, the debug function 21 indicates the fault occurrence timing corresponding to fault injection by “occurrence” and indicates the number of occurrences (twice).

### Second Embodiment

The fault injection program 10 according to a second embodiment is explained next. In the following explanations, elements different from those of the first embodiment are mainly explained. In the second embodiment, a variable value that causes fault injection is determined.

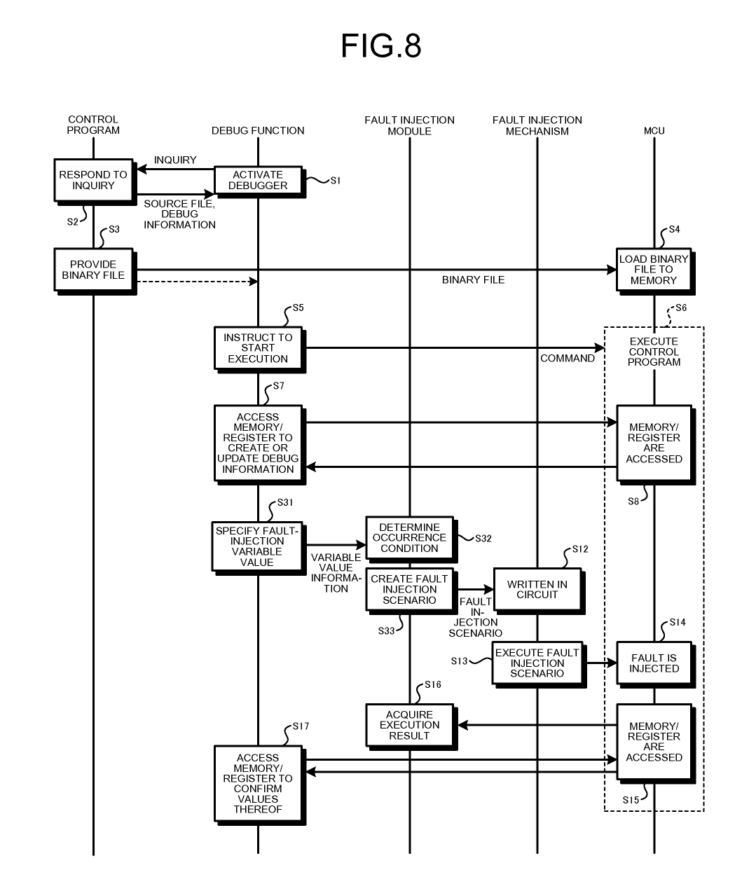

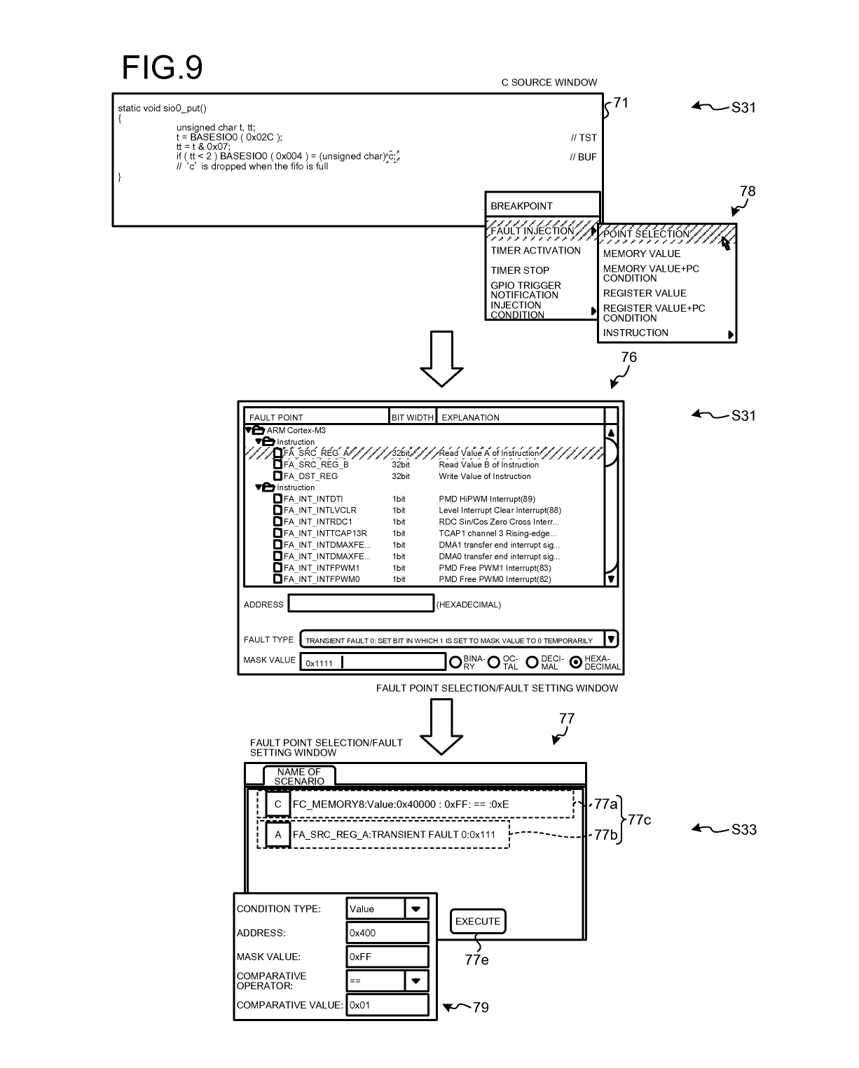

The fault injection module 11 determines an occurrence condition to cause fault injection as the fault injection condition. The occurrence condition includes a variable value to cause fault injection (for example, a register address and/or a memory address). Specifically, actions of the fault injection program 10 are different from those of the first embodiment in the following features as shown in FIGS. 8 and 9. FIG. 8 is a sequence diagram of an action of the fault injection system 100. Instead of the actions at S9 to S11 (see FIG. 2), the fault injection system 100 performs actions at S31 to S33 shown in FIG. 8.

The debug function 21 specifies variable value information (S31). The variable value information relates to a variable value to cause fault injection. For example, when a user selects a variable in a desired line of code on the source window 71 on which the source code is displayed to perform a predetermined operation, the debug function 21 causes the display unit 40 to display the cooperation menu object 78. When the user right-clicks a mouse in a state where the user drags the mouse to select a line of code, the cooperation menu object 78 is displayed. FIG. 9 illustrates a state where a variable “c” in a line of code “if(tt<2)BASESIO0(0x004)=(unsigned char)c;” is selected and highlighted. Corresponding thereto, the debug function 21 specifies a variable value (a register address and/or a memory address) corresponding to the variable “c”.

The debug function 21 extracts an allocation destination of the variable (a register address and/or a memory address). When the allocation destination of the variable is the memory, the debug function 21 extracts a memory size and a memory address. When the allocation destination of the variable is the register, the debug function 21 extracts the register address. Alternatively, when the variable is a local variable, the debug function 21 extracts a program counter value in a live range (a memory address to be stored in a program counter).

When a user selects “fault injection”→“point selection” in the cooperation menu object 78, the debug function 21 causes the display unit 40 to display the fault-point selection/fault setting window 76 on the screen. When the user selects a fault type on the fault-point selection/fault setting window 76, the debug function 21 specifies a register address and/or memory address.

The debug function 21 converts the register address and/or memory address to data for the fault injection module 11 and notifies the fault injection module 11 of the data as variable value information (condition related information). Furthermore, the debug function 21 converts action information of the selected fault injection (action related information) to data for the fault injection module 11 and notifies the fault injection module 11 of the data.

The fault injection module 11 edits the scenario by using the fault-injection-scenario editing function 12 based on the information notified from the debug function 21. For example, the fault injection module 11 determines the register address and/or memory address as the occurrence condition based on the variable value information, and determines an action entry to specify the fault injection action based on the action information (S32).

The fault-injection-scenario editing function 12 creates the fault injection scenario 77c based on the occurrence condition and the action entry (S33). The fault-injection-scenario editing function 12 creates the condition description 77a based on the occurrence condition and writes the condition description 77a in the fault injection scenario 77c. In the condition description 77a shown in FIG. 9, “C” defines a condition, and “FC_MEMORY8:Value:0x40000:0xFF:==:0xE” defines the contents of the condition. The description indicates that fault injection is performed at a point when the memory address becomes “0x40000”.

It should be noted that FIG. 9 exemplifies a condition description when the allocation destination of the variable is the memory. When the allocation destination of the variable is the register, a fault injection point can be defined under a condition of ‘the register address+register value’, or under a condition of ‘the register address+read action’. Alternatively, a fault injection point can be defined under a condition of ‘the register address+write action’, or under a condition of ‘the register address+access action’.

Furthermore, the fault-injection-scenario editing function 12 creates the action description 77b based on the determined action entry and writes the action description 77b in the fault injection scenario 77c. In the action description 77b shown in FIG. 9, “A” defines an action, and “FA_SRC_REG_A: TRANSIENT FAULT 0:0x111” defines the contents of the action. The description indicates that a fault is caused in a value of the register “REG A”.

It should be noted that the fault-injection-scenario editing function 12 can edit the fault injection scenario 77c such as rewrite on the fault-scenario editing window 77 via an input window 79, upon reception of a command corresponding to an instruction from a user. Similar contents to the fault-scenario editing window 77 are displayed on the input window 79, and the rewritten part is synchronized and changed also on the fault-scenario editing window 77. The condition type can be selected from Read/Write/Access/Value, and “Value” corresponding to the occurrence condition has been selected.

As described above, according to the second embodiment, the fault injection module 11 determines the occurrence condition that specifies a variable value for causing fault injection in cooperation with the debug function 21. The occurrence condition includes the register address and/or memory address to cause fault injection at the time of executing the control program 30. Accordingly, the fault injection module 11 can easily set the occurrence condition in cooperation with the debug function 21.

It should be noted that the fault injection module 11 can make an inquiry to the debug function 21 about easily acquirable information by using the debug function (a register address and/or a memory address) before the action at S31, as in the first embodiment. Instead of a user, the fault injection module 11 performs selection of the variable value to cause fault injection. Accordingly, the variable value to cause fault injection can be selected without performing any interactive operation with the user. Accordingly, the burden on the user in fault injection can be further reduced.

Alternatively, instead of determining the fault injection point on the source window 71 in the C language, the fault injection point can be determined on the disassembly window 71′. The debug function 21 acquires the binary file 32 after the source file 31 is compiled to the binary file 32 at the time of activation of the debugger 20 (see the broken arrow extending from S3 in FIG. 8). The debug function 21 disassembles the binary file 32 and displays the description in the assembly language between corresponding lines with respect to the respective lines in the source code in the C language on the source window 71.

In a modification of the second embodiment, when a user selects a desired line of code in the description in the assembly language on the disassembly window 71′ to perform a predetermined operation, the debug function 21 displays the cooperation menu object 78. For example, a part “r7” of a line of code in the description in the assembly language “000001d8:71fbstrb r3, [r7, #7]” corresponding to a line of code “BASEGPIO(0x004)=(unsingned int)c;” is selected, and highlighted and displayed. In the description, “r3” and “r7” denote a register address, and “#7” denotes a memory address. Corresponding thereto, the debug function 21 specifies the register address and/or memory address. Subsequent actions of the modification are similar to those of the second embodiment.

Alternatively, the fault injection point can be determined on the memory dump window 72. At S31, the debug function 21 displays contents dumped from the memory 62 on the memory dump window 72. A user selects a desired memory value on the memory dump window 72. Corresponding thereto, the debug function 21 specifies the memory address. Subsequent actions of the modification are similar to those of the second embodiment.

Alternatively, the fault injection point can be determined on the register window 73. At S31, the debug function 21 displays the contents acquired from the register 63 on the register window 73. The user selects a desired register address and a register value on the register window 73. Corresponding thereto, the debug function 21 specifies the register address. Subsequent actions of the modification are similar to those of the second embodiment.

Alternatively, the fault injection point can be determined on the watch window 74. At S31, the debug function 21 displays the source code in the source file 31 on the C source window 71. When the source code in a predetermined range is selected on the source window 71, the debug function 21 displays variables, values thereof, and variable types included in the source code in the predetermined range on the watch window 74. The user selects a predetermined variable of the plurality of variables on the watch window 74. Corresponding thereto, the debug function 21 specifies the variable. Subsequent actions of the modification are similar to those of the second embodiment.

In this manner, the fault injection module 11 can determine the occurrence condition in cooperation with the respective windows. Accordingly, the occurrence condition can be determined, while confirming the variable to be used for execution of the line of code and the attribute thereof, and thus the occurrence condition can be determined accurately.

Alternatively, at the time of editing the fault injection scenario 77c, instead of editing the condition description 77a in the form related with the action description 77b, the condition description 77a can be edited in the form independent of the action description 77b. Accordingly, the fault injection module 11 can easily improve the flexibility at the time of editing the fault injection scenario 77c.

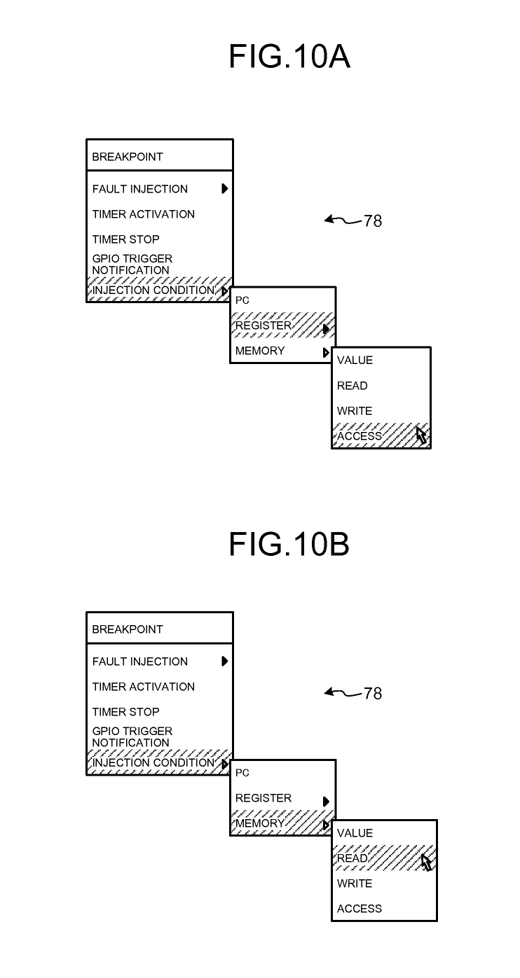

For example, a register condition (register address+value/read/write/access condition) can be created from the source code in the C language. As shown in FIG. 10A, when “injection condition”→“register”→“access” is selected in the cooperation menu object 78 in a state where a desired line of code is selected, the debug function 21 notifies the fault injection module 11 of a variable value “register address+access action” as the variable value information. Accordingly, the fault injection module 11 determines the occurrence condition according to the variable value information. The fault-injection-scenario editing function 12 independently creates the condition description 77a and writes the condition description 77a in the fault injection scenario 77c.

Alternatively, a memory condition (memory address+value/read/write/access condition) can be created from the source code in the C language. As shown in FIG. 10B, when “injection condition”→“memory”→“read” is selected in the cooperation menu object 78 in a state where a desired line of code is selected, the debug function 21 notifies the fault injection module 11 of a variable value “memory address+read action” as the variable value information. Accordingly, the fault injection module 11 determines the occurrence condition according to the variable value information. The fault-injection-scenario editing function 12 independently creates the condition description 77a and writes the condition description 77a in the fault injection scenario 77c.

Alternatively, the fault injection system 100 can have a function of jumping from the fault-scenario editing window 77 to the respective windows 71 to 74 of the debug function 21 as the interface function between the fault injection module 11 and the debug function 21. Accordingly, it can be confirmed whether the fault injection timing defined in the fault injection scenario 77c is appropriate.

For example, when a user selects the “memory dump window” in the cooperation menu object 81 in a state where the cursor is positioned on a predetermined condition description, the fault injection module 11 notifies the debug function 21 of variable information corresponding to the condition description. The debug function 21 refers to the debug information 32a to specify a memory value corresponding to the variable information (a memory address). Corresponding thereto, the fault injection module 11 causes the display unit 40 to jump the cursor to the memory dump window 72 (not shown), and the debug function 21 causes the display unit 40 to highlight and display the memory value associated with the fault injection scenario 77c on the memory dump window 72.

Alternatively, when a user selects the “watch window” in the cooperation menu object 81 in a state where the cursor is positioned on the predetermined condition description, the fault injection module 11 notifies the debug function 21 of the variable information corresponding to the condition description. The debug function 21 refers to the debug information 32a to specify a variable corresponding to the variable information (a memory address). Corresponding thereto, the fault injection module 11 causes the display unit 40 to jump the cursor to the watch window 74, and the debug function 21 causes the display unit 40 to highlight and display the variable associated with the fault injection scenario 77c on the watch window 74.

Alternatively, when a user selects the “register window” in the cooperation menu object 81 in a state where the cursor is positioned on the predetermined condition description, the fault injection module 11 notifies the debug function 21 of the variable information corresponding to the condition description. The debug function 21 refers to the debug information 32a to specify a register address and a register value corresponding to the variable information (a register address). Corresponding thereto, the fault injection module 11 causes the display unit 40 to jump the cursor to the register window 73, and the debug function 21 causes the display unit 40 to highlight and display the register address and the register value associated with the fault injection scenario 77c on the register window 73.

Alternatively, the debug function 21 can cause the display unit 40 to display an execution result of the fault injection scenario 77c on the screen in such a form that the fault injection point and the fault occurrence state can be respectively identified. Accordingly, the fault occurrence status and the like can be displayed straightforwardly, and the association between the fault injection point and the fault occurrence state can be easily ascertained.

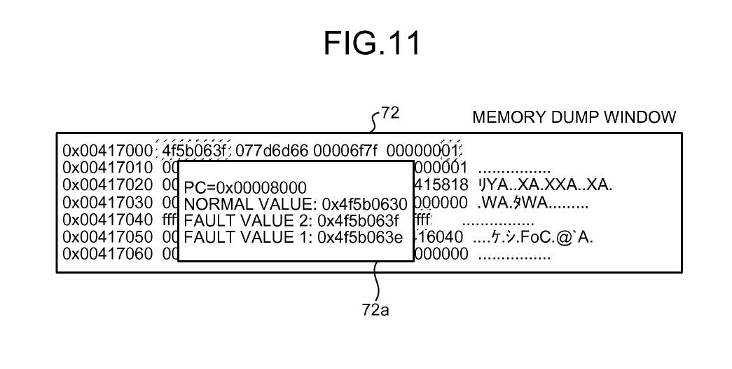

For example, as shown in FIG. 11, a status of a memory value fault (an execution result of the fault injection scenario 77c) is displayed on the memory dump window 72. The debug function 21 can cause the display unit 40 to display a window 72a showing a program counter value, a normal value, and a fault value, overlapped on or adjacent to the memory dump window 72. Accordingly, a memory address and a memory value having a fault due to fault injection can be ascertained, and how the fault has occurred (which bit has been broken) can be confirmed. Furthermore, an injection and occurrence timing (a program counter value) and the number of occurrences can be confirmed. When the fault has occurred plural times, the history thereof can be confirmed.

### Third Embodiment

The fault injection program 10 according to a third embodiment is explained next. In the following explanations, elements different from those of the first embodiment are mainly explained. In the third embodiment, the action description 77b is edited in the form independent of the condition description 77a.

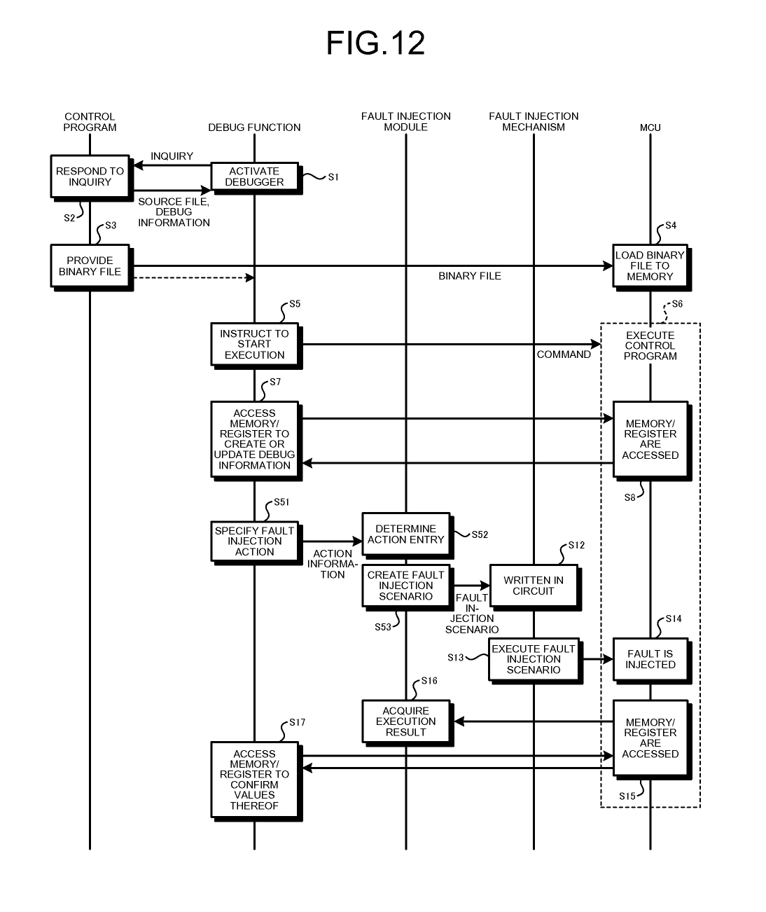

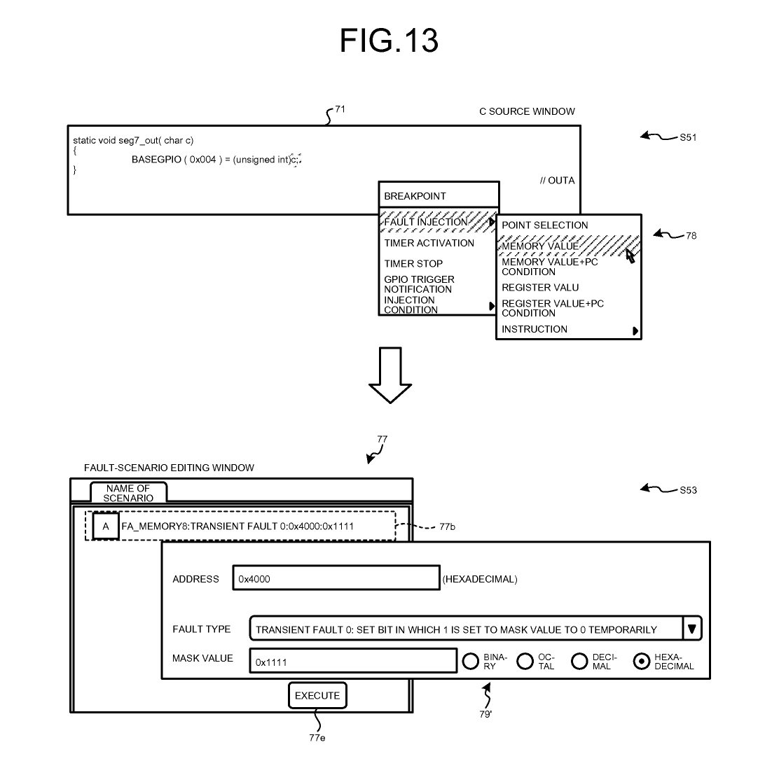

The fault injection module 11 determines an action entry that specifies an action of fault injection as the fault injection action. The action entry includes causing a fault in a memory value. Specifically, actions of the fault injection program 10 are different from those of the first embodiment in the following features, as shown in FIGS. 12 and 13. FIG. 12 is a sequence diagram illustrating an action of the fault injection system 100. FIG. 13 illustrates the action of the fault injection system 100. Instead of the actions at S9 to S11 (see FIG. 2), the fault injection system 100 performs the actions at S51 to S53 shown in FIG. 12.

The debug function 21 specifies action information (S51). For example, when a user selects a variable in a desired line of code on the source window 71 on which the source code is displayed to perform a predetermined action, the debug function 21 displays the cooperation menu object 78. When the user right-clicks a mouse in a state where the user drags the mouse to select a line of code, the cooperation menu object 78 is displayed. FIG. 13 illustrates a state where a variable “c” in a line of code “BASEGPIO(0x004)=(unsigned int)c;” is selected and highlighted. Corresponding thereto, the debug function 21 specifies a register address and/or memory address corresponding to the variable “c”.

The debug function 21 extracts an allocation destination of the variable (a memory address and/or a register address) from the debug information 32a. When the allocation destination of the variable is the memory, the debug function 21 extracts a memory size and a memory address. When the allocation destination of the variable is the register, the debug function 21 extracts the register address. When the variable is a local variable, the debug function 21 extracts a program counter value in the live range.

When a user selects “fault injection”→“memory value” in the cooperation menu object 78, the debug function 21 notifies the fault injection module 11 of the action information of the selected fault injection (action related information). The fault injection module 11 determines the memory address to have a fault and a memory value to have a fault as the action entry (S52).

The fault-injection-scenario editing function 12 creates the fault injection scenario 77c based on the action entry (S53). The fault-injection-scenario editing function 12 creates the action description 77b based on the determined action entry and writes the action description 77b in the fault injection scenario 77c. In the action description 77b shown in FIG. 13, “A” defines an action, and “FA_MEMORY8: TRANSIENT FAULT 0:0x4000:0x1111” defines the contents of the action. The description indicates to cause a fault in a memory value at a memory address of “0x4000”.

As described above, in the third embodiment, the fault injection module 11 determines the action entry that specifies the fault injection action in cooperation with the debug function 21. The action entry includes causing a fault in a memory value at the time of execution of the control program 30. At this time, the fault-injection-scenario editing function 12 can edit the action description 77b in the form independent of the condition description 77a. Accordingly, the fault injection module 11 can improve the flexibility easily at the time of editing the fault injection scenario 77c.

It should be noted that the fault-injection-scenario editing function 12 can edit the condition description 77a in the form independent of the action description 77b as above (see FIG. 5). Accordingly, in a modification of the third embodiment, after writing the condition description in the fault injection scenario 77c in the form independent of the action description before performing the action description, the action description can be written in the fault injection scenario 77c in the form independent of the condition description, as in the third embodiment. As a result, the condition description and the action description can be written independent of each other in the fault injection scenario 77c and correlated to each other in a state after the condition description and the action description are written.

Alternatively, as in the first embodiment, the fault injection module 11 can make an inquiry to the debug function 21 about easily acquirable information before the action at S51. Instead of a user, the fault injection module 11 selects the fault injection action. Accordingly, the fault injection action can be selected without performing any interactive action with the user. Accordingly, the burden on the user in fault injection can be reduced further.

Alternatively, instead of determining the fault injection action on the source window 71 in the C language, the fault injection action (a fault in the register value) can be determined on the disassembly window 71′. The debug function 21 acquires the binary file 32 after the source file 31 is compiled to the binary file 32 at the time of activation of the debugger 20 (see the broken arrow extending from S3 in FIG. 12). The debug function 21 disassembles the binary file 32 and causes the display unit 40 to display the description in the assembly language between corresponding lines with respect to the respective lines in the source code in the C language on the source window 71. That is, the debug function 21 causes the display unit 40 to display the source code in the C language and the description in the assembly language in a mixed state on the disassembly window 71′.

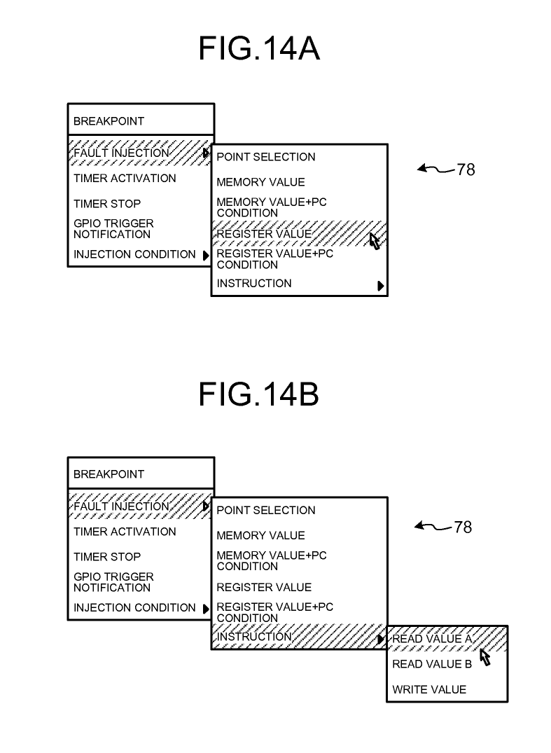

In the modification of the third embodiment, when the user selects a variable in a desired line of code on the disassembly window 71′ to perform a predetermined action, the debug function 21 causes the display unit 40 to display the cooperation menu object 78. As shown in FIG. 14A, when a user selects “fault injection”→“register value” in the cooperation menu object 78, the debug function 21 specifies a fault in the register value at the selected register address as a fault injection action. Subsequent actions of the modification are similar to those in the third embodiment.

Alternatively, as the fault injection action to be determined on the disassembly window 71′, instead of a fault in the register value, a fault in a read value or a write value of the code can be determined. For example, when the user selects a read value “sp” in a line of code in a description “000001d4: af00 add r7, sp, #0” in the assembly language to perform a predetermined action, the debug function 21 causes the display unit 40 to display the cooperation menu object 78. Corresponding thereto, the debug function 21 specifies a register address corresponding to the selected read value “sp”.

The debug function 21 extracts an allocation destination of a predetermined read value from the debug information 32a or the like. As shown in FIG. 14B, when a user selects “fault injection”→“instruction”→“read value A”, the debug function 21 recognizes that a fault in a register value of a register address corresponding to the selected read value is selected as the fault injection action. The debug function 21 then notifies the fault injection module 11 of the fault injection action information in response to the selection of the register value of the register address as the fault injection action.

Alternatively, instead of determining the fault injection action on the source window 71 in the C language, the fault injection action can be determined on the memory dump window 72. At S51, the debug function 21 causes the display unit 40 to display contents dumped from the memory 62 on the memory dump window 72. When the user selects a desired memory value on the memory dump window 72 to perform a predetermined action, the debug function 21 displays the cooperation menu object 78.

When the user selects “fault injection”→“memory value” in the cooperation menu object 78, the debug function 21 refers to the debug information 32a or the like to specify a memory address having the selected memory value. The debug function 21 specifies a fault in the memory value of the memory address as the fault injection action. Subsequent actions of the modification are similar to those of the third embodiment.

Alternatively, the fault injection action can be determined on the register window 73. At S51, the debug function 21 causes the display unit 40 to display contents acquired from the register 63 on the register window 73. When the user selects a desired register value on the register window 73 to perform a predetermined action, the debug function 21 causes the display unit 40 to display the cooperation menu object 78.

The debug function 21 causes the display unit 40 to display the cooperation menu object 78, overlapped on the register window 73 in response that the mouse is right-clicked, in a state where the register value is selected. When the user selects “fault injection”→“register value” in the cooperation menu object 78, the debug function 21 refers to the debug information 32a or the like to specify a register address having the selected register value. The debug function 21 specifies a fault in the register value of the register address as the fault injection action. Subsequent actions of the third embodiment are similar to those of the third embodiment.

Alternatively, the fault injection action can be determined on the watch window 74. At S51, the debug function 21 causes the display unit 40 to display a source code in the source file 31 on the C source window 71. When the user selects the source code in a predetermined range on the source window 71, the debug function 21 causes the display unit 40 to display variables, values thereof, and variable types included in the source code in the predetermined range on the watch window 74. When the user selects a desired variable on the watch window 74 to perform a predetermined action, the debug function 21 causes the display unit 40 to display the cooperation menu object 78. The debug function 21 extracts an allocation destination of the selected variable from the debug information 32a or the like.

When the user selects “fault injection”→“memory value” in the cooperation menu object 78, the debug function 21 refers to the debug information 32a or the like to specify a memory address allocated to the selected variable. The debug function 21 specifies a fault in a memory value of the memory address as the fault injection action. Subsequent actions of the modification are the same as those of the third embodiment.

In this manner, the fault injection module 11 can determine the action entry in cooperation with the respective windows. Accordingly, an action entry that is related to a variable to cause a fault can be determined, while confirming the variable to be used for execution of the line of code and the attribute thereof. Accordingly, the action entry can be determined accurately.

It should be noted that, in the first to third embodiments, respective conditions in order to perform fault injection can be diverted to an external trigger notification (GPIO). An arbitrary timing in the program according to the respective conditions can be used for the external trigger notification (GPIO). Accordingly, notifications can be given to outside upon establishment of the set condition, in cooperation with the debug function.

The notifications can be given to outside in combination of a PC condition (a timing condition), a timer condition (=timing condition+timer action), a memory access condition (an occurrence condition), and a memory value condition (an occurrence condition). In a simulation environment using an external tool (HILS or the like), when it is desired that a rotation speed sensor is broken down at the time of execution of a certain program counter value, the following actions are performed.

(1) External trigger notification setting is performed on the source code (the PC condition and a GPIO trigger notification action are set in a fault injection circuit). When the “GPIO trigger notification” is selected in the cooperation menu object 78 in a state where a desired line of command is selected on the source code of the control program 30, the debug function 21 selects the desired line of code as a GPIO trigger notification point. The debug function 21 refers to the debug information 32a to specify a program counter value corresponding to the desired line of code, in response that the desired line of code is selected as the GPIO trigger notification point in the cooperation menu object 78.

(2) The GPIO trigger notification is performed upon establishment of the condition during execution of the program. When a program counter value being executed becomes the program counter value set in (1), the GPIO trigger notification indicating that “because the condition has been established, please cause a fault in the rotation speed sensor of the motor” is sent from a GPIO terminal of an FPGA board to the external tool (HILS or the like).

(3) In the external tool (HILS or the like), an analog value (a voltage or a current) having a fault is input to an MCU board, assuming that the rotation speed sensor is broken down.

(4) It is monitored whether the motor misbehaves or the motor is broken down by a motor control command calculated based on the rotation speed input having a fault.

In this manner, an arbitrary timing during execution of the program can be notified to outside (an external tool such as HILS) by performing timing control of a trigger notification to outside.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nontransitory processor readable recording medium having a fault injection program recorded therein, the program causing a processor to perform:
providing, by a fault injection module, cooperation information to a debug function that performs debugging of a control program, which is operated by using a fault injection target;
receiving, by the fault injection module, a notification of at least one of condition related information and action related information as a response to the cooperation information from the debug function;
determining, by the fault injection module, at least one of a fault injection condition and a fault injection action based on the notification; and
creating, by the fault injection module, a fault injection scenario that defines a fault injection procedure with respect to the fault injection target based on at least one of the determined fault injection condition and fault injection action.

2. The nontransitory processor readable recording medium according to claim 1, wherein
the creating the fault injection scenario includes describing, by the fault injection module, a condition description corresponding to the determined fault injection condition and an action description corresponding to the determined fault injection action in the fault injection scenario such that the condition description and the action description are associated with each other.

3. The nontransitory processor readable recording medium according to claim 1, wherein
the notification to the fault injection module is specified by the debug function, in response to a selection operation of a user in a cooperation menu object displayed on a screen based on the cooperation information, or in response to an inquiry received from the fault injection module as the cooperation information.

4. The nontransitory processor readable recording medium according to claim 3, wherein
the debug function creates debug information, and
the notification to the fault injection module is extracted from the debug information and is notified to the fault injection module by the debug function, in response to the selection operation of the user or in response to an inquiry from the fault injection module.

5. The nontransitory processor readable recording medium according to claim 3, wherein
the condition related information includes timing information that is related to a timing to perform fault injection, and
the fault injection condition includes a timing condition that specifies a timing to perform fault injection.

6. The nontransitory processor readable recording medium according to claim 5, further causing the processor to perform:
providing a source file of the control program from the debug function to the fault injection module; and
parsing a source code in the source file by the fault injection module, wherein
the providing the cooperation information includes providing, by the fault injection module, an inquiry about information required for determination of at least one of the fault injection condition and the fault injection action to the debug function as the cooperation information, according to a parsing result.

7. The nontransitory processor readable recording medium according to claim 3, wherein
the condition related information includes variable value information that is related to a variable value to cause fault injection, and
the fault injection condition includes an occurrence condition that specifies a variable value to cause fault injection.

8. The nontransitory processor readable recording medium according to claim 7, further causing the processor to perform:
providing a source file of the control program from the debug function to the fault injection module; and
parsing a source code in the source file by the fault injection module, wherein
the providing the cooperation information includes providing, by the fault injection module, an inquiry about information required for determination of at least one of the fault injection condition and the fault injection action to the debug function as the cooperation information, according to a parsing result.

9. The nontransitory processor readable recording medium according to claim 3, wherein
the action related information includes action information that is related to contents of a fault injection action, and
the fault injection action includes an action entry that specifies contents of the fault injection action.

10. The nontransitory processor readable recording medium according to claim 9, further causing the processor to perform:
providing a source file of the control program from the debug function to the fault injection module; and
parsing a source code in the source file by the fault injection module, wherein
the providing the cooperation information includes providing, by the fault injection module, an inquiry about information required for determination of at least one of the fault injection condition and the fault injection action to the debug function as the cooperation information, according to a parsing result.

11. A fault injection method comprising:
providing, by a fault injection module, cooperation information to a debug function that performs debugging of a control program, which is operated by using a fault injection target;
receiving, by the fault injection module, a notification of at least one of condition related information and action related information as a response to the cooperation information from the debug function;
determining, by the fault injection module, at least one of a fault injection condition and a fault injection action based on the notification; and
creating, by the fault injection module, a fault injection scenario that defines a fault injection procedure with respect to the fault injection target based on at least one of the determined fault injection condition and fault injection action.

12. The fault injection method according to claim 11, wherein
in the creating the fault injection scenario includes describing, by the fault injection module, a condition description corresponding to the determined fault injection condition and an action description corresponding to the determined fault injection action in the fault injection scenario such that the condition description and the action description are associated with each other.

13. The fault injection method according to claim 11, wherein
the notification to the fault injection module is specified by the debug function, in response to a selection operation of a user in a cooperation menu object displayed on a screen based on the cooperation information, or in response to an inquiry received from the fault injection module as the cooperation information.

14. The fault injection method according to claim 13, further comprising creating debug information by the debug function before providing the cooperation information, wherein
the notification to the fault injection module is extracted from the debug information and is notified to the fault injection module by the debug function, in response to the selection operation of the user or in response to an inquiry from the fault injection module.

15. The fault injection method according to claim 13, wherein
the condition related information includes timing information that is related to a timing to perform fault injection, and
the fault injection condition includes a timing condition that specifies a timing to perform fault injection.

16. The fault injection method according to claim 15, further comprising:
providing a source file of the control program from the debug function to the fault injection module; and
parsing a source code in the source file by the fault injection module, wherein
the providing the cooperation information includes providing, by the fault injection module, an inquiry about information required for determination of at least one of the fault injection condition and the fault injection action as the cooperation information, according to a parsing result.

17. The fault injection method according to claim 13, wherein
the condition related information includes variable value information that is related to a variable value to cause fault injection, and
the fault injection condition includes an occurrence condition that specifies a variable value to cause fault injection.

18. The fault injection method according to claim 17, further comprising:
providing a source file of the control program from the debug function to the fault injection module; and
parsing a source code in the source file by the fault injection module, wherein
the providing the cooperation information includes providing, by the fault injection module, an inquiry about information required for determination of at least one of the fault injection condition and the fault injection action as the cooperation information, according to a parsing result.

19. The fault injection method according to claim 13, wherein
the action related information includes action information that is related to contents of a fault injection action, and
the fault injection action includes an action entry that specifies contents of the fault injection action.

20. The fault injection method according to claim 19, further comprising:
providing a source file of the control program from the debug function to the fault injection module; and
parsing a source code in the source file by the fault injection module, wherein
the providing the cooperation information includes providing, by the fault injection module, an inquiry about information required for determination of at least one of the fault injection condition and the fault injection action as the cooperation information, according to a parsing result.
